(19) United States
(12) Patent Application Publication
(10) Pub. No.: US 2003/0158805 A1
(43) Pub. Date: Aug. 21, 2003

(54) Method of translating electronic data interchange documents into other formats and in reverse

(76) Inventor: Brian Mozhdehi, Philadelphia, PA (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/072,803

(22) Filed: Feb. 8, 2002

(51) Int. Cl. G06F 17/60

(52) U.S. Cl. 705/37

(57) ABSTRACT

A method for translation between electronic data interchange and at least one other data format comprising the following steps: using configuration information about the structure of an inbound EDI document, so as to read the EDI document one segment at a time; parsing each segment and noting each segment identifier; noting any associated loop information, either in the form of controlling loop information in the document as specified in the first section of this document, or from association with stored configuration information; noting the unique number of any qualifying data encountered with its matching values as specified in the configuration information from the database; and noting the associated data and the defined name of each element; noting two additional linking values represented s at least two variables such that the variables describe the occurrence of headers and details in the physical file being read; storing the data into a database table; and translating the file from the database table into a second format.

### FIELD OF THE INVENTION

The present invention is directed to systems and methods for translating electronic data interchange (EDI) documents into other formats and to a system and method for reversing the process. In particular, the present invention is directed to systems for translating EDI documents into flat files, relational database tables and/or XML files and documents, and for reversing the process.

### BACKGROUND OF THE INVENTION

The present invention is directed to systems that facilitate both the complete translation of X12 EDI documents into any of flat files, relational database tables and/or XML documents and the translation of data stored in flat files, relational database tables and/or XML documents into complete X12 EDI documents.

EDI Structures

EDI, or Electronic Data Interchange, is comprised of a set of standardized documents that define content and structure for data contained within a file that represents relevant business data. For example, in X12 an “856” document represents an advance shipment order, which may be sent to a warehouse to inform them that goods are to be arriving for storage. An example “856” document is shown below:

ISA*00* *00* *08*9254530005 *08*9416650966P

*010410*1249*U*00400*000002854*0*P*>˜GS*SH*064792773*9416650966P*200104

10*1249*17782*X*004010˜

ST*856*0001˜

BSN*00*0080483140*20010410*1249*0001*AS˜

HL*1**S˜

TD1******G*43050*LB˜

TD5*****XYZ CORPORATION*CC˜

TD3*TL˜

REF*SI*921094˜

REF*ZZ*0000468879˜

DTM*067*20010411˜

DTM*011*20010410˜

N1*ST*XYZ Corporation—XYZ˜

N3*3000 Any State Road˜

N4*MyCity*MyState**US˜

N1*SF*ABC Corporation˜

N3*65 Any Street˜

N4*Any Town*Any State**US˜

HL*2*1*O˜

PRF*4500215476***20010410˜

HL*2*2*P˜

LIN*000001*VN*00000811282*LT*PSUG˜

SN1**1050*BA˜

SE*20*0001˜

GE*1*1772˜

IEA*1*000002854˜

Each line of data shown above represents a so-called “segment” in EDI. Each segment contains business data in the form of “elements” that are separated by a so-called de-limiter. The first element on each line of data serves as an identifier for the line which is called a “segment identifier”.

For example, on the following line from the document:

N1*ST*XYZ Corporation—XYZ˜

“N1” represents the segment identifier.

“*” represents the delimiter, “ST”, “XYZ Corporation—XYZ”, etc, each represent the content of an element that contains business data.

Each of the elements containing business data are associated with names which are defined in an “EDI specification.” An EDI specification is a human readable document that describes the various segments that appear in the EDI document in each transmission of the document between parties. The specification further describes each element that appears on each segment, providing a name for each element.

Each segment in the document is further characterized either as a header, detail or summary segment. A header or a summary segment contains singular information for the associated business document for which the EDI representation has been generated. For example, a purchase order may contain billing information, the purchaser's name, shipping address information, total invoice amount, etc. A detail segment usually represents repeating unique information about the business document represented. For example, a purchase order may contain several items purchased by the purchaser in the same business transaction.

Each segment may also be part of a loop. A loop is a group of segments that repeat within the same document. In a header segment, this usually represents a grouping of segments whose business meanings are all linked and whose data has been qualified by some qualifying element in the first segment in the loop. For each instance of the loop, each element of data for each segment has to be interpreted differently when translating the document.

For detail segments, a loop generally represents the entire set of detail segments (for which the loop has redundant meaning with the details) or the loop can introduce some additional details about each detail. This second scenario follows the same logic as a header segment, except that the information contained is for detail level data as opposed to header data. Summary segments generally do not have loops associated with them.

There are frequently physical indications internal to an EDI Document that indicate the beginning and/or end of a loop. For example, the following notation may appear within an EDI document indicating that the contained segments are part of a loop.

LS*N101˜

N1*ST*XYZ Corporation—XYZ˜

N3*3000 Any State Road˜

N4*MyCity*MyState**US˜

N1*SF*ABC Corporation˜

N3*65 Any Street˜

N4*Any Town*Any State**US˜HL*2*1*O˜

LE*N101˜

Where

LS*N101˜ denotes the beginning of loop N101

LE*N101˜ denotes the end of loop N101

It is to be stressed that the above notation is optional, and as such, often comprises the only physical indication that a loop is the EDI specification. Each element of each segment represents a piece of business data that needs to be interpreted or generated. For example, an N1 segment usually represents name information for a person or entity. In the example above: N1*ST*XYZ Corporation—XYZ˜XYZ Corporation—XYZ is the name of an entity that is associated or involved in the represented business transaction.

Some elements represent qualifying elements. This means that the data contained within the element has no general meaning, in and of itself, but simply acts as a qualifier for the rest of the data on the containing segment. Qualifiers can extend their influence on the meaning of the data beyond the containing segment to the loop in which the segment is contained.

To further explore looping and element qualifiers and their interpretations, the following example is set forth:

N1*ST*XYZ Corporation—XYZ˜

N3*3000 Any State Road˜

N4*MyCity*MyState**US˜

N1*SF*ABC Corporation˜

N3*65 Any Street˜

N4*Any Town*Any State**US˜HL*2*1*O˜

The above represents a loop of data, i.e. a group of segments that repeat consecutively in the document. Each set of segments has its own particular business data meaning. The manner in which segments can be discerned from each other is by use of a qualifying element; in the above example, the first element in the N1 segment. For the first loop, the qualifier “ST” appears, which in the X12 standard for an 856, means “Ship To”. The name and address information in the rest of the loop is therefore to be interpreted as “Ship To” information. The second loop, the qualifying element has a value of “SF”, which in the X12 856 definition stands for “Ship From”. The data in the rest of the loop should be interpreted as “Ship From” information.

It is critical to note that segment and loop qualifiers do not have to be singular in the elements used. Qualifying elements can appear in the form of multiple elements, which can cause the interpretation of the business meaning of the data to become more complex.

To summarize the above, EDI data can be properly interpreted by a combination of the ability to recognize and interpret business data as such data appears in the document, based upon on the read in segments. This data is recognized by the segment identifiers, such as above where the value N1 appearing at the beginning of a line, data elements based upon a specification that defines the name and business meaning of the elements as they appear on a segment, and the loops and qualifying data elements, where they appear and/or are relevant. With this combination, EDI data can be successfully mapped to other data representations. Conversely, EDI can be generated by the ability to map data from other data representations into the above combinations.

There are a number of prior patents which relate to software mapping and translation. U.S. Pat. No. 6,336,137, for example, is directed to a Web based-server system and method for incompatible page markup and presentation languages. The invention comprises a client-server system and methods for transferring data via a network, including a wireless network, between a server and one or more clients or browsers that are spatially distributed (i.e., situated at different locations). At least one local client computer provides a user interface to interact with at least one remote server which implements data processing in response to the local client computer. The user interface may be a browser or a thin client.

U.S. Pat. No. 6,336,124 is directed to a computer-implemented method of converting a document in an input format to a document in a different output format. The method generally comprises locating data in the input document, grouping the data into one or more intermediate format blocks in an intermediate format document, and converting the intermediate format document to the output format document using the intermediate format blocks. Each intermediate format block may be a paragraph, a line, a word, a table or an image. The input document may be received over a network and the output may also be sent over the network. A linked Table of Contents and/or and index may be generated. A computer executable program may be generated and inserted into the output document for selecting one output format for display. The output document may be displayed by locating sub-page breaks in the document, subdividing the document into sub-pages using sub-page breaks, locating blocks within each sub page and sequentially displaying all or a portion of each block of the sub pages within display parameters of a display configuration. Tables may be divided to be displayed in more than one display page. The converter may be incorporated in a computer program product for maintaining a repository of input documents in one or more storage formats.

U.S. Pat. No. 6,308,178 discloses a system for integrating data among heterogeneous source applications and destination applications including a knowledge repository containing temporary data storage for storing data from source applications during processing for population in the destination applications, a library of data elements each providing a discrete data manipulation friction, configuration data storage for storing user-provided information describing the integration environment, and a plurality of add-on modules for functions corresponding to a particular destination application. The underlying interface communication and processing functions are performed by an active component or engine, which according to the data configuration and the module instruction sets.

U.S. Pat. No. 6,199,195 discloses a method for generating source code objects and as the steps of generating a plurality of logical models using a plurality of modeling tools, translating each of the plurality of logical models into corresponding ones of a plurality of unified models; generating a system definition comprising a plurality of templates each defining at least one service within a framework and generating at least one source code object as a function of one of the plurality of models. The system is designed to be carried out in a method employing modeling tools of the schema repository and a schema server.

None of the prior art disclose systems for the translation of EDI into files such as XML, flat files and the like on a process for reversing the translation.

It is a principal object of the present invention to provide a system for the translation of EDI into files such as XML, flat files and the like and a process for reversing the translation.

It is a further object of the present invention to facilitate the interpretation and generation of EDI documents by providing data tables to store specification information about each document.

It is a further object of the present invention to provide for the special storage of qualifying elements, which allows qualifying data to be associated with a unique numeric key.

It is a further object of the present invention to provide a method and system for translating EDI documents into flat files, relational database and XML files.

These and other objects of the present invention will become apparent from the attached detailed description and claims.

### SUMMARY OF THE INVENTION

The present invention is directed to a method and system for translating EDI documents into flat files, relational database files and XML files and the like. In order to facilitate the interpretation and generation of EDI documents, the present invention provides data tables to store specification information about each document. In addition, the present invention provides a special storage of qualifying elements, which allows qualifying data to be associated with a unique numeric key.

In accordance with the present invention, then, the invention is a method for translation between electronic data interchange and at least one other data format comprising the following steps. The invention comprises using configuration information about the structure of an inbound EDI document, so as to read the EDI document one segment at a time; parsing each segment and noting each segment identifier; noting any associated loop information, either in the form of controlling loop information in the document as specified in the first section of this document, or from association with stored configuration information; noting the unique number of any qualifying data encountered with its matching values as specified in the configuration information from the database; noting the associated data and the defined name of each element; noting two additional linking values represented as at least two variables such that the variables describe the occurrence of headers and details in the physical file being read; storing the data into a database table; and translating the data from the database table into a second format.

In a more preferred embodiment, the invention is directed to a method to translate between EDI to and from other data formats such as database table, flat files, and XML comprising the following steps: reading an inbound EDI document one segment at a time using configuration information about the structure of said inbound EDI document and determining for each segment, its status as a header, detail or summary segment; parsing each segment and noting its segment identifier; determining any associated loop information, either in the form of controlling loop information in the document, or that associated with stored configuration information, is also noted as each segment; noting whether any qualifying data is encountered with matching values as specified in stored configuration information and noting any unique number; noting for each segment element; the associated data and the defined name of the element; noting two additional linking values describing the occurrence of headers and details in the segment file being read; storing all data and all noted information of segment in a database table as below; translating data from the database table into a desired format based upon the data representation and mapping information stored in the database; using a query language to extract data into the form necessary to write a desired translated target. These and other objects of the present invention will become clear from the following detailed description and claims.

### BRIEF DESCRIPTION OF THE FIGURES

FIG. 1 is a block diagram of a computer based operational system in accordance with the present invention.

FIG. 2 is a block diagram of a computer based operational system as used in the context of a global computer network.

FIG. 3 is a flow diagram of the method of the present invention

### DETAILED DESCRIPTION OF THE PRESENT INVENTION

The present invention is directed to a system in which EDI data can be translated into other formats and in which the process can be reversed. While the present invention is being described in the context of a system using a personal computer, the manner of the particular end user device is not critical to the present invention. The present invention may be used with any system that connects to the Internet or uses other IP transport methods. The end user device can comprise any end user device which connects to a network such as a wireless device, palm pilot, PDA, end user workstation or hand-held device. Alternatively, the present invention is directed to a system which can operate locally as a stand alone system or as part of an Internet, LAN and WAN.

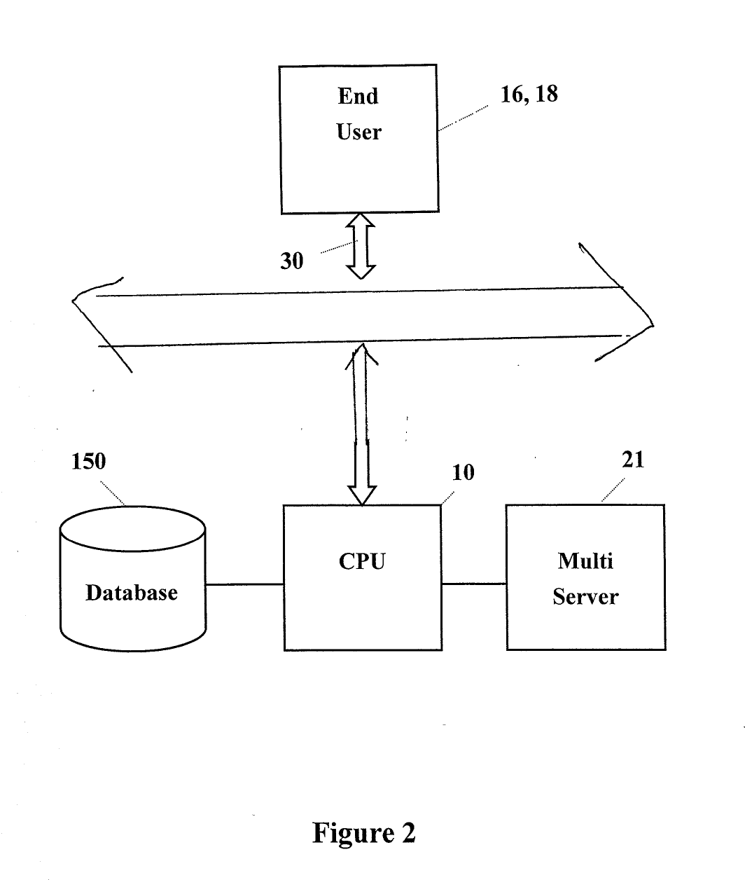

The technical operational background of one embodiment of the present invention is now described. Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway.” Companies such as America Online, CompuServe and Prodigy, which traditionally provided so-called “content” over proprietary networks, have begun to provide access by personal computer users to an expansive international network of computer networks known as the Internet. It is to be appreciated that the teachings of the present invention are equally applicable to stand alone, non-web based systems as shown in FIG. 2 comprising an end user station 14, CPU 55 and database 150.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word. The present invention is thus designed, in one embodiment, to be utilized on the World Wide Web or Internet, although the present invention is equally applicable to other network environments. As noted above, the present invention is similarly related to user interfaces which are not computers such as palm pilots, wireless and cellular devices.

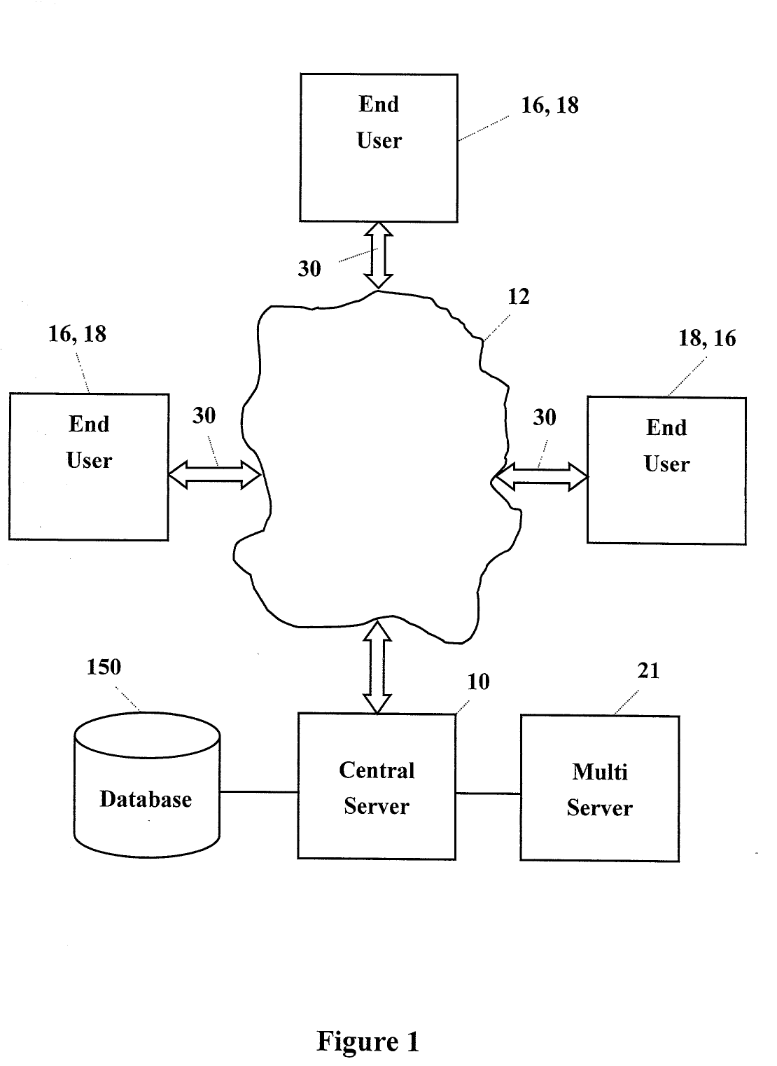

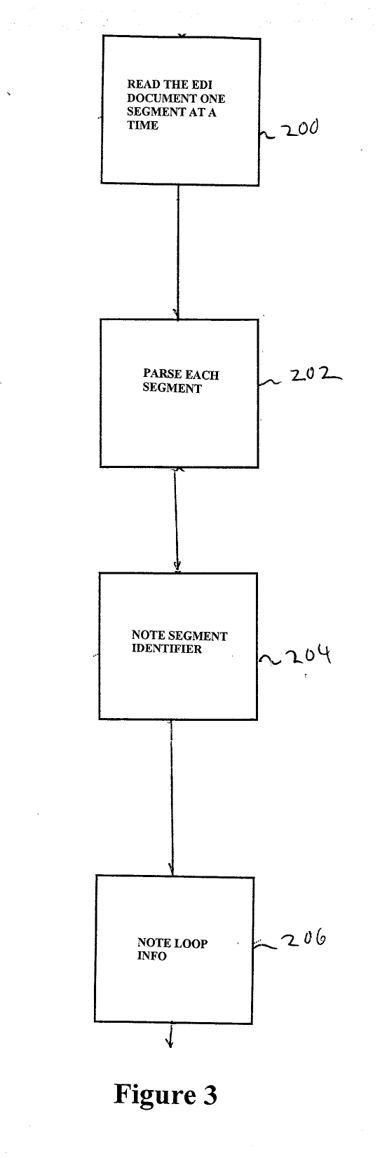

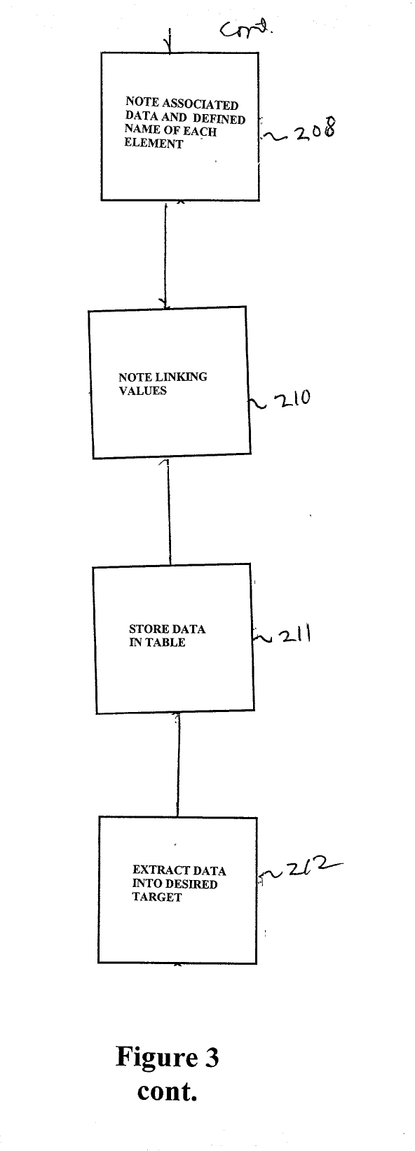

Referring to FIG. 1, a preferred embodiment of a system for the present invention is now disclosed and shown. As will be discussed here in, the present invention is directed to a system for translating EDI data. A preferred embodiment comprises a central computer server 10 connected by a computer network 12 to remote end user stations 14. The central server connects to a database 150 which contains a plurality of programs and algorithms associated with the present invention and not clearly described in the Section relating to FIG. 3. As shown in FIG. 2, the present invention is also applicable to stand alone and intranet or network systems.

In a preferred embodiment, end user stations 14 comprise a plurality of end users 16, 18. End users 16, 18, are defined herein as individuals linked to the system who may comprise medical practitioners, medical care providers and medical specialists. For purposes of this disclosure, a medical practitioner is defined as an individual who desires professional information and the like and wishes to utilize the system of the present invention.

Users 16, 18 are linked with the central computer server 10 via a transport medium 30. End users 16, 18, in a most preferred embodiment, will be linked via a global computer network 12 such as the Internet or Worldwide web, but other embodiments including LANs, WANs and Intranets, fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system and system clients. Through communication link and transport medium 30, end users 16, 18 will receive data entries which must be correctly identified and confirmed and who are linked to the central server 12, preferably by a customizable interface. FIG. 2 illustrates a local system in which the system of the present invention may be accessed via a LAN, WAN or intranet

In order to facilitate the interpretation and generation of EDI documents, the operation of the system is now more fully described with reference to FIG. 3. The present invention provides data tables to store specification information about each document. In addition, the invention provides for a special storage of qualifying elements, which allows qualifying data to be associated with a unique numeric key. For example, to as shown in the above example:

N1*ST*XYZ Corporation—XYZ˜

N3*3000 Any State Road˜

N4*MyCity*MyState**US˜

N1*SF*ABC Corporation˜

N3*65 Any Street˜

N4*Any Town*Any State**US˜HL*2*1*O˜

As discussed, ST and SF in element number one of each of the N1 segments represent qualifying elements. The invention allows the user to specify that each of these values, when appearing on the N1 segment in position one, represents some unique numeric key. The significance of this feature will be discussed later in the mapping section of this document.

The following is a description of the tables used in accordance with the present invention to store EDI definition information. For purposes of this disclosure, the definitions have been limited to relevant columns and tables that are relevant to our discussion.

Table Name: EdiFormat

| Columns: | |
|---|---|
| Column Name | Data Type |
| EdiFormatKey | Integer |
| EdiFormatName | String |

Table Name: EdiSegments

| Columns: | |
|---|---|
| Column Name | Data Type |
| EdiFormatKey | Integer |
| EdiSegmentKey | Integer |
| SegmentId | String |
| ContainedIn | Integer |
| LoopId | String |

Table Name: EdiSegmentData

| Columns: | |
|---|---|
| Column Name | Data Type |
| EdiFormatKey | Integer |
| EdiSegmentKey | Integer |
| EdiDataKey | Integer |
| DataName | String |
| DataPosition | Integer |

Table Name: EdiSegmentDataValues

| Columns: | |
|---|---|
| Column Name | Data Type |
| EdiFormatKey | Integer |
| EdiSegmentKey | Integer |
| EdiDataKey | Integer |
| EdiDataValueKey | Integer |
| GroupNumber | Integer |
| DataValue | String |

Other Data Structures

Flat Files

Flat files are typically represented as either position defined or delimited files with rows of data, in which each row represents a complete set of information about particular business data. Each piece of separated data may be represented by a name that can be used to define a specification for reading and/or writing the file. The present invention allows this specification to be stored in its database for use in translation.

For example purposes, the tables used to define a flat file profile are shown below.

Table Name: FlatFileFormat

| Columns: | |
|---|---|
| Column Name | Data Type |
| FlatFormatKey | Integer |
| FormatName | String |
| Type | Integer |
| Delimiter | String |

Table Name: FlatFileData

| Columns: | |
|---|---|
| Column Name | Data Type |
| FlatFormatKey | Integer |
| FlatFileDataKey | Integer |
| DataName | String |
| Position | Integer |

Database Tables

A database table is a collection of columns of data sorted into rows. The structure, if not the use, is very similar to that of a flat file as described above. The invention permits this specification to be stored in its database for use in translation.

XML Documents

XML documents are hierachial documents that are represented as tags that contain information. Each tag represents the name of the data elements contained. For example, the following represents an example of a reference to an order number in an XML document.

<Order Number>000010010</OrderNumber>

XML differs from other data formats since the specification for the data contained in an XML document is contained within the document itself. For XML, the present invention uses a technology called x-path, which not only defines the tagging properties of each element, but also can represent the particular element's position in the hierarchy. The invention allows users to reference the x-path of each element with a name that can be used for mapping. The invention permits the specification to also be stored in its database for use in translation.

Data Mapping

In order to facilitate the translation of business data to and from EDI into and out of other data representations, a mapping definition must be defined that associates elements of data represented in one format to elements of data in another format. While EDI must be interpreted as a combination of the containing segment, the data element name, the position of the segment as a header, detail or summary segment and any containing loops or qualifying element, other forms of data typically can be represented by its data name only.

When mapping EDI to and from other data structures, the following tables are used to represent the mapping between definitions:

Table Name: DataMap

| Columns: | |
|---|---|
| Column Name | Data Type |
| MappingKey | Integer |
| DataMapName | String |
| Type | Integer |
| FromFormatKey | Integer |
| ToFormatKey | Integer |

Table Name: DataMapDetail

| Columns: | |
|---|---|
| Column Name | Data Type |
| MappingKey | Integer |
| MappingDetailKey | Integer |
| FromContainer | Integer |
| FromSegment | String |
| FromLoopId | String |
| FromGroupKey | Integer |
| ToContainer | Integer |
| ToSegment | String |
| ToLoopId | String |
| ToGroupKey | Integer |
| FromDataName | String |
| ToDataName | String |

The FromContainer and ToContainer fields contain, where appropriate, numeric values representing either whether the mapped segment is a header, detail, or summary segment. The FromGroupKey and ToGroupKey fields are used to represent the assigned numbers for qualifying elements. When EDI is read by the system, qualifying elements are encountered. The system references the associated data for translation using the user defined and assigned numeric values, as discussed above.

When reading EDI, the toContainer, ToSegment, ToLoopId and ToGroupKey are not used. The ToDataName represents the name of the data element for the destination profile, e.g. the flat file element mapped to. Similarly, the EDI related from values are not used when writing EDI.

With the above explanation, and referring to FIG. 3, the present invention utilizes a unique two-step process to execute translation between EDI to and from other data formats such as database table, flat files, and XML. The process for translating EDI into other formats is described as follows.

Initially, using configuration information about the structure of an inbound EDI document, the system reads the EDI document one segment at a time 200. The sequence of segments as they appear in the file being read and the associated definition of these segments as specified in the database configuration information, permit the reading process to determine, for each segment, its status as a header, detail or summary segment.

Each segment is then parsed 202 and its segment identifier is noted 204. Any associated loop information, either in the form of controlling loop information in the document, or that associated with stored configuration information, is also noted as the segment is read 206. If any qualifying data is encountered with matching values as specified in the configuration information from the database, the unique number defined is noted. Finally, for each element, the associated data and the defined name of the element are noted 208.

Two additional linking values are also noted and represented in memory as two variables 210. These are referred to as the headerkey and detailkey. These variables describe the occurance of headers and details in the physical file being read. As the document starts, the headerkey is initially set to 1 and the detailkey is set to 0.

As soon as the first detail is read, the detailkey is set to 1. For each complete set of detail segments read, the detail key is then incremented. Once the details have been entirely read for a document, the summary segments, if any, are read with the existing header value. The detail value is reset to 0 and used for all summary segments. This is because summary and header segments can be interpreted businesswise as the same. If another document appears in the same file, as interpreted by the appearance of subsequent header segments, the headerkey is incremented to represent a new document.

As each segment is read, its data and all noted information is stored in a database table 211 as below.

Table Name: EDIHoldingTable

| Columns | |
|---|---|
| Column Name | Data Type |
| BatchCode | Integer |
| ContainedIn | Integer |
| SegmentId | String |
| LoopId | String |
| DataName | String |
| DataValue | String |
| HeaderKey | Integer |
| DetailKey | Integer |
| GroupKey | Integer |

Once the document is read and all data has been inserted into the table, the first step of the translation has been concluded. As a result of the first step, the process required to complete the translation of the EDI document has been reduced to translating data from a database table into a desired format 212. Because information about a data representation is stored in the database and mapping information between the stored formats is also stored in the database, the fact that the source information also in a database table allows the use of a query language such as SQL (Simply Query Language) to extract data into the form necessary to write the desired target data 214.

The following code snippet illustrates the SQL involved for selecting EDI data into a cursor parsable for building a flat file document based upon the flat file specification.

SELECT EdiHoldingTable.DataValue, FlatFileData.DataName,

EdiHoldingTable.HeaderKey, EdiHoldingTable.DetailKey,

FlatFileData.DataType FROM EdiHoldingTable, FlatFileData, DataMap, DataMapDetail

WHERE EdiHoldingTable.SegmentId=DataMapDetail.FromSegment

AND EdiHoldingTable.DataName=DataMapDetail.FromDataName

AND EdiHoldingTable.Containedin=DataMapDetail.FromContainer AND

EdiHoldingTable.GroupKey=DataMapDetail.FromGroupKey AND

DataMap.ToFormatKey=FlatFileData.FlatFormatKey AND DataMap.MappingKey=

DataMapDetail.MappingKey AND DataMapDetail.ToDataName=

FlatFileData.DataName AND Flatfiledata.FlatFormatKey=:flatFileFormatKey AND

DataMap.MappingKey=:mappingKey AND EdiHoldingTable.BatchCode=:batchCode

GROUP BY EdiHoldingTable.HeaderKey, EdiHoldingTable.DetailKey,

EdiHoldingTable.DataValue, FlatFileData.DataName, FlatFileData.DataType ORDER

BY EdiHoldingTable.HeaderKey, EdiHoldingTable.DetailKey

This query will result in data name, data value information, along with control information necessary to break out individual records. From there, the flat file document can be easily constructed based upon the stored configuration information for the flat file, which is desired to be constructed. Other document types such as XML, database inserts can be accomplished using similar queries using the appropriate tables and fields. EDI writing follows the reverse process. If reading a flat file into the system, the data is stored in the following table:

Table Name: FlatFileHoldingTable

| Columns: | |
|---|---|
| Column Name | Data Type |
| BatchCode | Integer |
| RowNumber | Integer |
| DataName | String |
| DataValue | String |

Then, the following query allows EDI data in the form of container (header, detail summary), segment identifier, loop identifier, data name, qualifying number and data value to use, along with control information to be retrieved and used to construct and EDI document. Construction from other data sources follows a similar process.

SELECT FlatFileHoldingTable. DataValue, Itrim(rtrim(EdiSegmentData.dataName)),

FlatFileHoldingTable. RowNumber, EdiSegmentData. DataType,

Itrim(rtrim(DataMapDetail.ToSegment)), DataMapDetail.ToGroupKey,

DataMapDetail.ToContainer, Itrim(rtrim(DataMapDetail.ToLoopId)), FROM

FlatFileHoldingTable, EdiSegmentData, DataMap, DataMapDetail WHERE

FlatFileHoldingTable.DataName=DataMapDetail.FromDataName AND

DataMap.ToFormatKey=EdiSegmentData.ediFormatKey AND DataMap. Mapping Key

=DataMapDetail.MappingKey AND DataMapDetail.ToDataName=

EdiSegmentData.DataName AND EdiSegmentData.ediFormatKey=ediFormatKey

AND DataMap.MappingKey=mappingKey AND FlatFileHoldingTable.BatchCode=

batchCode GROUP BY FlatFileHoldingTable.RowNumber, DataMapDetail.ToSegment,

DataMapDetail.ToGroupKey, DataMapDetail.ToContainer, DataMapDetail.ToLoopId,

EdiSegmentData. DataName, FlatFileHoldingTable.DataValue,

EdiSegmentData.DataType, ORDER BY FlatFileHoldingTable.RowNumber

The present invention has been described in the context of the above detailed description. It is to be appreciated that the true nature and scope of the present invention is be described in the context of the claims attached hereto.

1. A method for translating between electronic data interchange (EDI) and at least one second data format comprising the following steps:
using configuration information about the structure of an inbound EDI document, so as to read the EDI document one segment at a time;
parsing each segment of the EDI document and noting each segment identifier;
noting any associated loop information, either in the form of controlling loop information in the document as specified in the first section of this document, or from its association with stored configuration information; and
noting the unique number of any qualifying data and the associated matching values as specified in the configuration information from the database; and
noting the associated data and the defined name of each element;
noting two additional linking values represented s at least two variables such that the variables describe the occurrence of headers and details in the physical file being read;
storing the data into a database table; and
translating the data from the database table into a second data format using a simple query language.

2. The method of claim 1 wherein said electronic data interchange is translated into and out of EDI from other data formats such as database tables, flat files, and XML.

3. The method of claim 1 wherein said two additional linking values comprise headerkey and detailkey such that the variables describe the occurrence of headers and details in the physical file being read, and further such that as a document starts, the headerkey is set to a first value and the detailkey is set to a second value and as soon as the first detail is read, the detailkey is set to a second value and for each complete set of detail segments read, the detail key is incremented.

4. A method translate between EDI to and from other data formats such as database tables, flat files, and XML comprising the following steps:
reading an inbound EDI document one segment at a time using configuration information about the structure of said inbound EDI document and determining for each segment, its status as a header, detail or summary segment;
parsing each segment and noting its segment identifier;
determining any associated loop information of each segment, either in the form of controlling loop information in the segment, or that associated with stored configuration information;
noting any qualifying data with matching values as specified in stored configuration information and further noting any unique number;
noting, for each segment element; the associated data and the defined name of the element;
noting two additional linking values describing the occurrence of headers and details in the segment file being read;
storing all data and all noted information of segment in a database table as below;
translating data from the database table into a desired format based upon the data representation and mapping information stored in the database; and
using a query language to extract data into the form necessary to write a desired translated target.

5. The method claim 4 wherein the query language is SQL.
